(19) United States
(12) Patent Application Publication
(10) Pub. No.: US 2026/0368615 A1
(43) Pub. Date: Nov. 19, 2026

(54) MACHINE LEARNING FRAMEWORK FOR DETECTION OF ANOMALIES AND INSIGHTS FOR PROCUREMENT SYSTEM

(71) Applicant: 3M INNOVATIVE PROPERTIES COMPANY, St. Paul, MN (US)

(72) Inventors: Yera Hakobyan, Shoreview, MN (US); lan S. Remming, St. Paul, MN (US)

(21) Appl. No.: 19/135,754

(22) PCT Filed: Dec. 19, 2023
(86) PCT No.: PCT/IB2023/062901

§ 371 Date: Jun. 4, 2025

Related U.S. Application Data
(60) Provisional application No. 63/476,287, filed on Dec. 20, 2022.

(51) Int. Cl. G06N 20/00; G06Q 10/087

(52) U.S. Cl. CPC G06N 20/00; G06Q 10/087

(57) ABSTRACT

Systems and techniques for generating machine learning (ML) models for machine learning anomaly detection and procurement are described. The system includes a memory that includes a first set of data associated with procurements, a feature extraction module connected to the memory that extracts a first set of procurement feature vectors from the first set of procurement data, a feature vector labeler connected to the memory, the feature vector labeler associating a label with each feature vector in the first set of feature vectors, a machine learning modeler connected to the feature extraction module and to the feature vector labeler, a display connected to the machine learning modeler, the display capable of displaying, to a user, procurement opportunities identified in feature vectors by the model and of receiving, from the user, indications when a feature vector is miscategorized.

### TECHNICAL FIELD

This disclosure generally relates to machine learning and, more specifically, to machine learning frameworks used to detect anomalies in procurement systems.

### SUMMARY

In general, this disclosure describes a machine learning (ML) framework that generates machine learning anomaly detection models for procurement. As part of the framework, there are actions and processes to enable model self-tuning within a user feedback loop. The framework supports a “many models” approach to machine learning anomaly detection (1) where a set of models are mapped in one-to-one correspondence to the categories of a preselected data attribute (e.g., material ID or material group ID) and (2) where each model generates predictions for the data to which it is assigned. Detections are delivered to a business solution that may include scoring recommendations that assist users with identifying the most critical detections and thus provide insights to the problem solution. Detections can reveal opportunities for a company such as to avoid or reduce cost. The terms anomaly detection and anomaly prediction are used interchangeably in this text.

The ML framework described creates machine learning models that are trained to identify observations of predefined anomaly scenarios. In procurement, an anomaly is an abnormal feature that is either associated with an individual procurement transaction (e.g., a purchase price that deviates from the historical average) or associated with a collection of transactions (e.g., a divergent price trend relating to transactions for a specific material ID). Example scenarios include 1) the detection of price anomalies in procurement transactions and 2) the detection of price negotiation opportunities by comparison of transaction metrics to 3rd party indices. Scenarios may be drawn based on an object type to which observations are associated and for which predictions are generated by the model. For example, for transaction-level predictions, the object type may be a transaction ID. For material-level predictions, the object type may be a material ID.

Anomalies are reviewed by users and the framework includes mechanisms for receiving feedback based on, for instance, anomalies that were incorrectly identified (false positives) or anomalies that were missed (false negatives). The feedback is used to retrain the machine learning model.

In one example approach, the ML framework is used to assign labels to each object to mark positive and negative observations of the scenario. Labels are created via, for instance, one or more of rule-based algorithms, subject-matter expert review, or unsupervised learning models. The labels and vectors are merged to create the training data. A supervised learning algorithm may be trained with the training data and the resulting model deployed to the user feedback loop.

The above ML-based framework approach offers advantages over rules-based approaches by simplifying algorithm monitoring and maintenance, enabling model revision via user feedback, and enabling more granular application of ML models (e.g., ML models as granular as by object type or by United Nations Standard Products and Services Code (UNSPSC)). The ML-based approach also allows for quick and efficient development of ML models for new insight scenarios and the swift tuning of such models via user feedback.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a workflow diagram illustrating one example approach for developing a machine learning model for detecting anomalies in a procurement system, in accordance with one or more techniques of the disclosure.

FIG. 2 is a workflow diagram illustrating one example approach for updating the supervised machine learning model of FIG. 1, in accordance with one or more techniques of the disclosure

FIG. 3 is a workflow diagram illustrating in greater detail one example approach for updating the supervised machine learning model of FIG. 2, in accordance with one or more techniques of the disclosure.

FIG. 4 is a block diagram illustrating one example approach for developing a supervised many-models machine learning model for detecting anomalies in a procurement system, in accordance with one or more techniques of the disclosure.

FIG. 5 illustrates anomaly detection in an example of a price negotiating opportunity for a material purchased by an organization, in accordance with one or more techniques of the disclosure.

FIG. 6 is a flowchart illustrating a method of training a machine learning model, in accordance with one or more aspects of the disclosure.

FIGS. 7-11 show various applications of aspects of the present disclosure as it relates to price negotiation opportunities.

FIGS. 12-18 are generally directed to various techniques related to both rule-based and machine-learning based particular price negotiation opportunities (“PNOs”) determinations.

Like reference characters refer to like elements throughout the figures and description.

### DETAILED DESCRIPTION

Procurement systems are designed to apply consistent processes to product, supply, equipment and service procurement processes. Such systems often include automation of buyer processes to enable easy purchasing from suppliers, while constraining such purchases to, in some instance, customer-approved supplier lists. As noted above, in procurement, an anomaly is an abnormal feature that is either associated with an individual procurement transaction (e.g., a purchase price that deviates from the historical average) or associated with a collection of transactions (e.g., a divergent price trend relating to transactions for a specific material ID).

It can be advantageous to detect anomalies. For instance, a divergent price trend may indicate that the price does not reflect volume discounts, while a divergent downward trend may indicate a buying opportunity. Analysis of price vs. market trend may indicate that the price is lower than the market trend (providing a temporary buying opportunity) or that the price is higher than the market trend (providing an opportunity to renegotiate the price). It can be especially advantageous to detect anomalies automatically, providing quick insight into the market before the market can correct.

In general, detecting anomalies necessitates that a large volume of data be considered. For instance, as described in more detail below, historical data of many months (or even years) may be considered for a particular product, raw material, and the like, which may include many millions—or more—data points during the relevant time. Furthermore, and relatedly, the large amount and diverse nature of the data makes rules-based approaches cumbersome to design and challenging to maintain which can undermine the accuracy of systems implementing such approaches. For instance, machine learning (ML) based approaches can learn on multiple trends for the anomalous behavior. As a result, ML approaches provide additional advantages over more traditional rule-based anomaly detection. The ML framework described herein generates machine learning anomaly detection models for procurement. As part of the framework, there are actions and processes to enable model self-tuning within a user feedback loop. The framework supports a “many models” approach to machine learning anomaly detection where (1) a set of models are mapped in one-to-one correspondence to the categories of a preselected data attribute (e.g., material ID or material group ID) and (2) each model generates predictions for the data to which it is assigned. Consequently, it should be appreciated that the systems and techniques described herein are inextricably linked to the realm of computing technology generally, and ML approaches more specifically.

Models created by the framework are trained to identify observations of predefined anomaly scenarios. Example scenarios include the detection of price anomalies in procurement transactions or the detection of price negotiation opportunities by comparison of transaction metrics to 3rd party indices. Included in the scenario definition is a description of the object type to which observations are associated and for which predictions are generated by the model (e.g., for transaction-level predictions or material-level predictions, the object type may be a transaction ID or material ID, respectively).

In one example approach, a supervised machine learning model is used to detect anomalies in a procurement system. In one such example approach, the process for training a model includes transforming transaction and/or index data into a feature vector for each respective object in a set of objects. An outcome label is created and assigned to each object to mark positive and negative observations of the scenario. Labels are created by one or more of the following methods: labeling by rule-based algorithms, manual labeling by subject-matter experts, or labeling by unsupervised learning models. The labels and vectors are merged to create the training data. A supervised learning algorithm is trained with the training data and the resulting model is deployed to the user feedback loop.

In one example approach, the model creates a prediction during the user feedback loop for each applicable object in the dataset based on a feature vector that is calculated for the object. (In some example approaches, predictions are not generated for objects with insufficient or missing data.)

Users review the predictions and respond with feedback. User-identified false anomalies (i.e., false positive identifications of anomalies) are then added to the model training data, and the model is retrained on the updated dataset. The updated model is then deployed to the feedback loop and replaces the existing model.

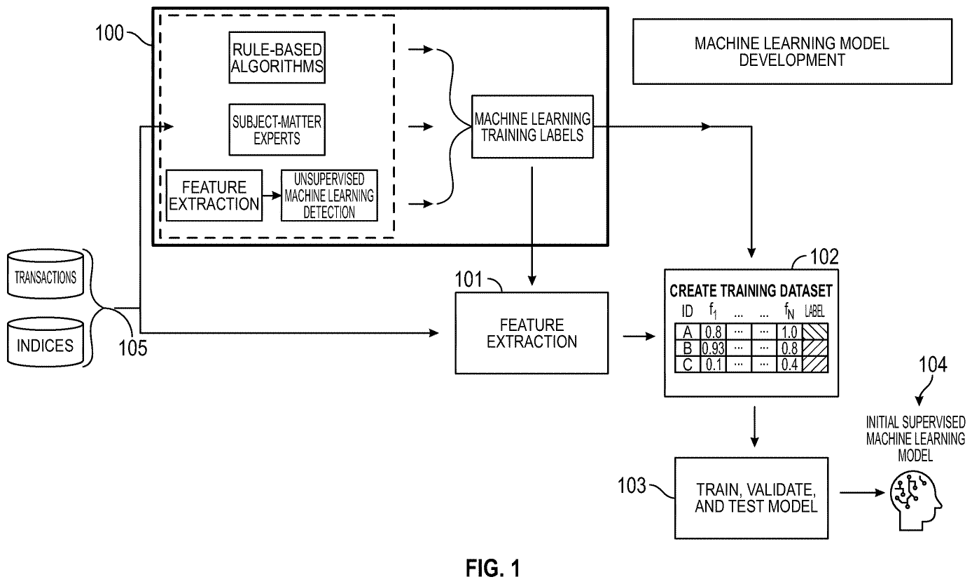

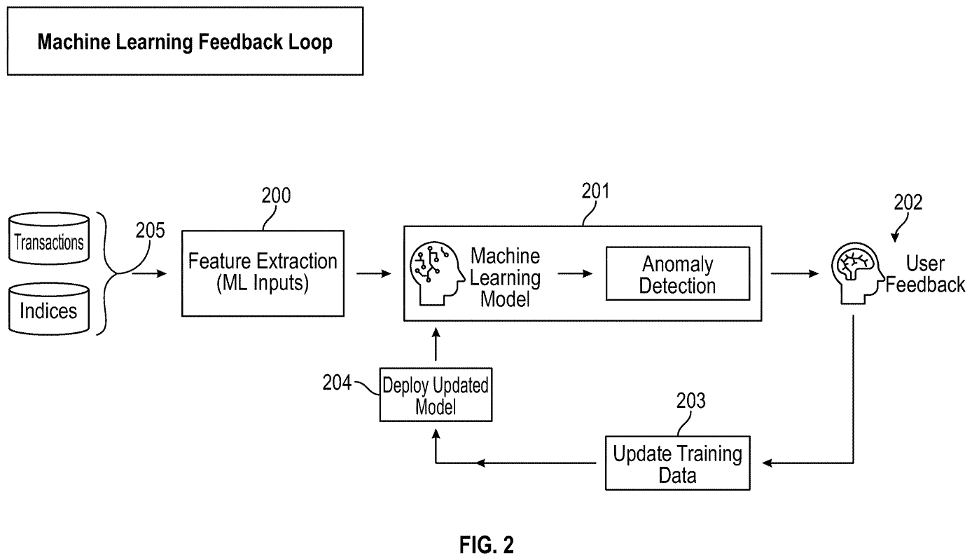

FIG. 1 is a workflow diagram illustrating one example approach for developing a machine learning model for detecting anomalies in a procurement system, in accordance with one or more techniques of the disclosure. In the example approach of FIG. 1, the workflow diagram shows a workflow for developing a supervised machine learning model for procurement anomaly detection. In the example shown, an initial ML model may be trained and deployed to generate predictions for every applicable object in the dataset. Furthermore, and as will be described in more detail below, the initial ML model may be refined using one or more feedback loops, such as the feedback loop described in reference to FIG. 2.

At 100, assign outcome labels to positive and negative observations of the anomaly scenario being modeled. The observations and labels are associated with objects within the dataset (e.g., a scenario for transaction anomaly detection would have transaction IDs as objects, and each object would be either a positive or negative observation of the scenario). Labels are derived from transactions and/or indices 105 (current implementation is using external indices) using one or more of the following methods: rule-based algorithms, subject-matter experts, and unsupervised machine learning detection.
At 101, for each labeled observation, the related historical data is transformed into a feature vector with components that are designed to be predictive of the anomaly scenario. After extracting a feature vector for each labeled observation, the components of each feature vector are transformed into the range of [0,1] by using a method of normalization (such as normalization described in more detail below). The normalization parameters that are calculated in this step are saved and used to normalize features that are extracted in the user feedback loop.
At 102, the labels and corresponding feature vectors are then combined to create a labeled dataset for supervised learning.
At 103, the labeled dataset is split, and one portion is used to train/configure the model to map input features to the correct labels. Model validation and testing is performed against the remaining labeled data. The model is then retrained on the larger labeled dataset. More testing is performed on the retrained model.
At 104, the model is deployed to the user feedback loop where it makes anomaly predictions and learns from user-provided feedback.

In one example approach, such as in the framework shown, training the machine learning model includes identifying the importance of each feature in the feature vector to a specific decision (e.g., identifying the features that correlate most closely with positive detections). Such features may then be, for example, emphasized in the model.

FIG. 2 is a workflow diagram illustrating one example approach for updating the supervised machine learning model of FIG. 1, in accordance with one or more techniques of the disclosure. In the example approach of FIG. 2, purchasing transactions for materials in storage 205 may be used to derive a training set that can be used to train a machine learning model. In the example shown in FIG. 2, a machine learning system extracts a feature vector for each object of a certain object type that is stored in storage 205 (200). In contrast to the approach used in FIG. 1, where a feature vector calculated for each object that received a label in step 100 is used to create the training data (102), in the example shown in FIG. 2, the machine learning model has been deployed and requires a feature vector for each object in the dataset to generate predictions across the data for a given model. Again, in some example approaches, the normalization parameters calculated in 101 are used in 200 to normalize each feature vector. The model then processes the feature vectors to detect the positive observations of the scenario (201). Information about these observations is displayed in the business solution to provide users insights to potential opportunities for the company and, in some cases, to receive feedback when a user determines the result shown is a false negative or a false positive.

In some example approaches, the labels of feature vectors associated with false positives or negatives are modified (203) and the relabeled feature vectors are used in a revised training set to train a machine learning model to identify such anomalies (204). The trained machine learning model is updated (201) and again reviewed by one or more users (202), who identify false positives and false negatives. The vectors identified as false positives or false negatives are again labeled to reflect the correct identification, fed back into the training set (203) and used to deploy a revised supervised machine learning model based on the updated training set (204).

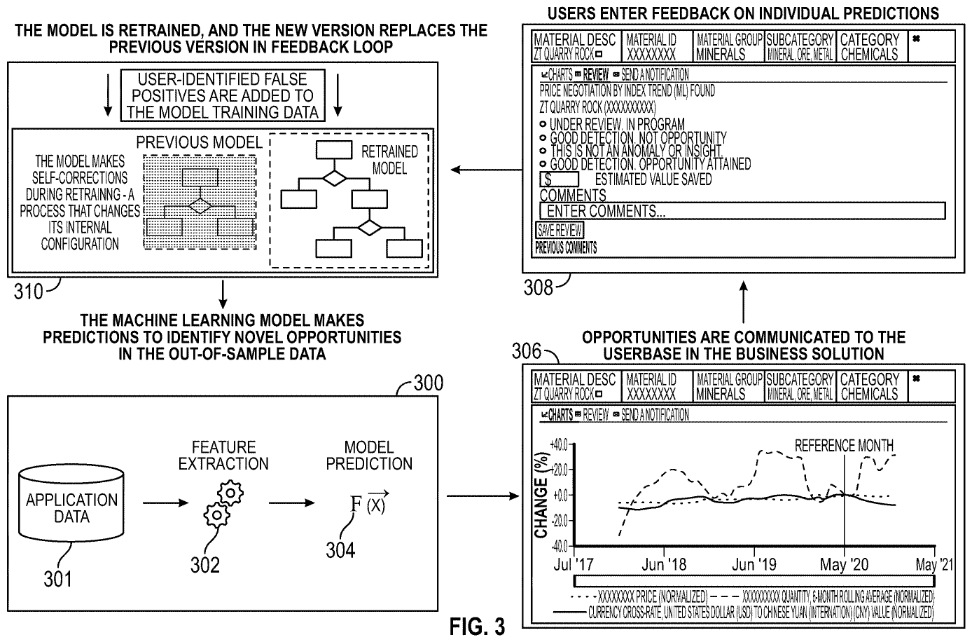

FIG. 3 is a workflow diagram illustrating in greater detail one example approach for updating the supervised machine learning model of FIG. 2, in accordance with one or more techniques of the disclosure. For instance, according to particular implementations, the machine learning model is deployed in such a manner that it can be used to detect opportunities in the current and/or updated data. In the example shown in FIG. 3 and starting with the machine learning detection step (300), feature vectors 302 are extracted from the application data in storage 301 and are applied to the machine learning model 304 to detect opportunities in the data (e.g., anomalies that may represent opportunities for advantageous procurement arrangements). These opportunities are presented to the users (306). The users provide feedback on the opportunities, identifying, for instance, false positive indicators of opportunities (308). The indicated false positives are added to the training data and the revised training data is used to train a new supervised machine learning model (310).

In one example approach, a procurement management system includes memory, a feature extraction module connected to the memory, a feature vector labeler connected to the memory, a machine learning modeler connected to the feature extraction module and to the feature vector labeler and a user interface connected to the machine learning modeler. The memory includes a first set of data, the data associated with procurements. The feature extraction module extracts a first set of procurement feature vectors from the first set of procurement data, each feature vector identifying one of the procurements and including features associated with the procurement. The feature vector labeler associates a label with each feature vector in the first set of feature vectors, the labels identifying procurement opportunities in the first set of feature vectors. The machine learning modeler includes a model trained with the first set of feature vectors while the user interface is configured to display, to a user, procurement opportunities identified in feature vectors by the model and of receiving, from the user, indications when a feature vector is miscategorized. The machine learning modeler then forms a retraining set of feature vectors based on the first set of feature vectors and the mischaracterized feature vectors and retrains the model. In one example approach, the procurement data is transaction data. In another example approach, the procurement data is based on an index of items. In one example approach, the feature vector labeler labels feature vectors based on one or more of pre-defined rules, review by subject matter experts, and unsupervised machine learning detection. In one example approach, the anomaly is a procurement opportunity. In one such example approach, the procurement opportunity is a price divergence. In another such example approach, the procurement opportunity is a price change.

Alternatively, a many-models solution may be deployed to the user feedback loop. In this scenario copies of the initial model are mapped in one-to-one correspondence to distinct categories of a preselected data attribute. For example, the models may be mapped to distinct material IDs or to higher levels of a material classification hierarchy. In one example, the hierarchy may be, for instance, material, material group, sub-category, and category. In one such example, the UNSPSC (United Nations Standard Products and Services Code) taxonomy, an industry-standardized classification is used for material group classification, while the categories and sub-categories are not part of a standardized taxonomy. In one such example approach, the sub-categories include sub-categories such as Acrylic Film, Adhesives, Foams and Legal Services, while the categories include categories such as Chemicals, Packaging, Polymers, R&D, and Finance. Each model is deployed separately to the user feedback loop and generates predictions only for the ID to which it is mapped.

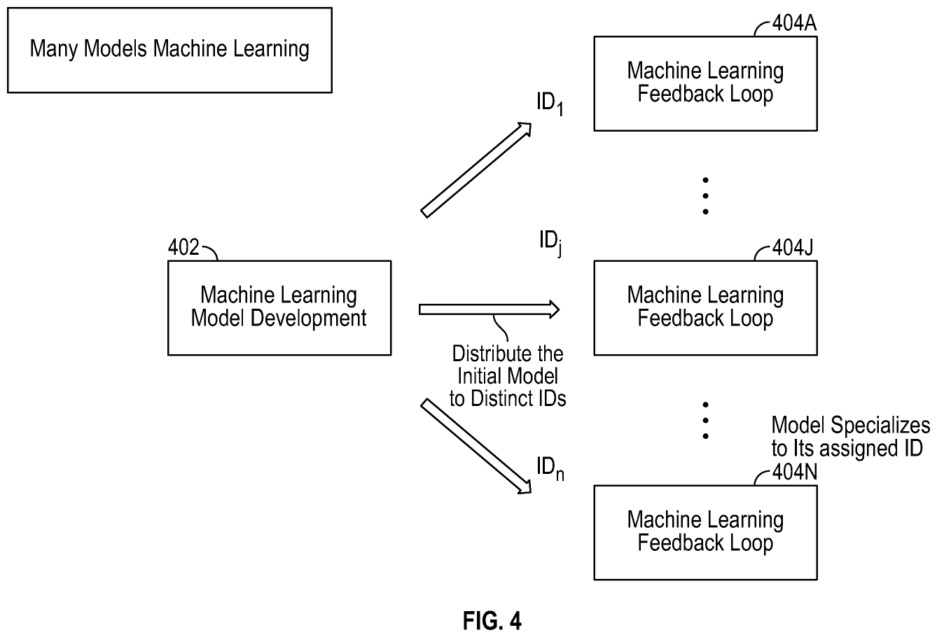

FIG. 4 is a block diagram illustrating one example approach for developing a supervised many-models machine learning model for detecting anomalies in a procurement system, in accordance with one or more techniques of the disclosure. In the example shown in FIG. 4, the procurement system 402 includes an initial model 402. The initial model 402 is mapped in one-to-one correspondence to machine learning feedback loops 404 by distinct categories, sub-categories or other levels of aggregation. For example, the models may be mapped to distinct material IDs or to higher levels of a material classification hierarchy. Model retraining occurs separately for each individual feedback loop 404, with training data consisting of the previous training data plus any user-identified false anomalies associated with the given model. The ongoing retraining of the models results in a set of personalized models that are tuned to their respective IDs.

In one example approach, one or more machine learning feedback loops 404 are assigned to distinct materials 404A, 404J, and 404N. In another example approach, one or more machine learning feedback loops 404 are assigned to distinct material groups 404A, 404J, and 404N consisting of distinct sets of materials. Other examples include deploying machine learning feedback loops for distinct sub-categories or categories also consisting of distinct sets of materials. Each feedback loop 404 is modified based on feedback (e.g., false anomalies) provided by users for its appropriate material or its appropriate materials that make up the material group, sub-category or category as appropriate for the specific approach.

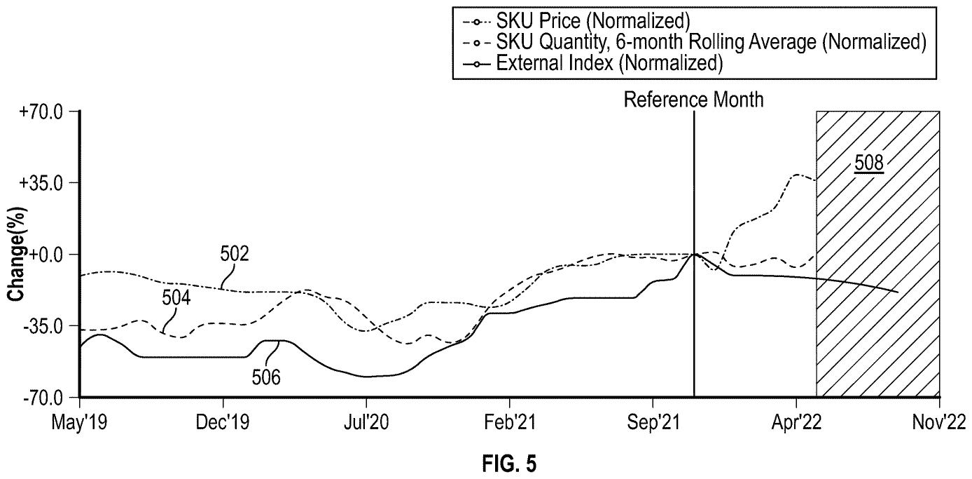

FIG. 5 illustrates anomaly detection in an example of a price negotiating opportunity for a material purchased by an organization. The lines 502, 504, and 506 are the monthly average unit price for the material, the six-month rolling average of the monthly quantity totals of the material, and a related external index, respectively. The region 508 on the chart denotes future months and contains the forecasted values of the external index. The monthly average unit price (as reflected by line 502) is trending up, and the external index (as reflected by line 506) is on a downtrend in the most recent months. The divergence between the price and index creates an opportunity for the company to negotiate a price reduction for this material and take advantage of the deflating market.

As described above, training the machine learning model includes identifying the importance of each feature in the feature vector to a specific decision (e.g., identifying the features that correlate most closely with positive detections).

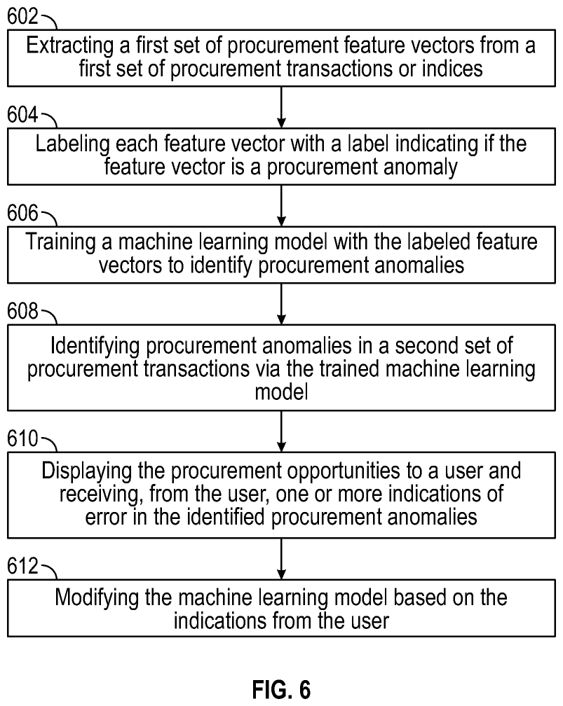

FIG. 6 is a flowchart illustrating a method of training a machine learning model, in accordance with one or more aspects of the disclosure. In the flowchart illustrated in FIG. 6, a first set of procurement feature vectors is extracted from a first set of procurement transactions or indices, each feature vector identifying one or more of the procurement transactions and including features associated with the one or more procurement transactions (602). Each feature vector is labeled with a label indicating if the feature vector is a procurement anomaly (604). A machine learning model is then trained with the labeled feature vectors to identify procurement anomalies (606).

Identifying procurement anomalies in a second set of procurement transactions or indices using the trained machine learning model (608). In one example approach, a second set of procurement feature vectors is obtained from the second set of procurement transactions or indices. The second set of feature vectors is then applied to the trained machine learning model, wherein applying includes identifying procurement anomalies in the second set of second set of procurement feature vectors extracted from a second set of procurement transactions. The procurement anomalies identified are presented to a user and feedback from the user indicates whether any of the identifications are in error (610). The machine learning model is then retrained based on the feedback from the user (612).

Even though FIG. 6 does not show an iterative approach, such as the feedback loop discussed in the context of FIG. 2 above, it should be appreciated that systems configured to perform the method shown in FIG. 6 can do so in a manner that accommodates the feedback loop describe above and shown in other FIGS. For instance, after modifying the machine learning model based on the indications from the user (612), it may be advantageous to re-identify procurement anomalies in the second set of procurement transactions (608), to name one example, which may result in a feedback loop similar to the one described above in FIG. 2.

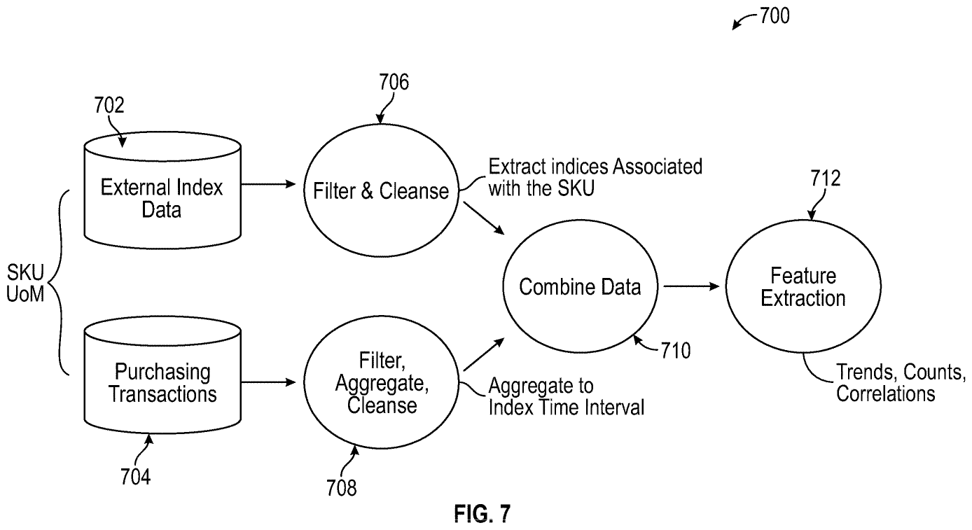

FIGS. 7-11 show various applications of aspects of the present disclosure as it relates to a particular price negotiation opportunities (“PNOs”) example. In general, the machine learning approaches of the present disclosure provide a number of advantages, including simplifying algorithm monitoring and maintenance, enabling model self-correct through a user feedback loop, generating specialized models to different levels of data aggregation (e.g., UNSPSC), and initiating new models for additional insight scenarios. In short, the dynamic nature of the machine learning approaches results in improved accuracy for systems configured as described herein as the machine learning approaches, e.g., self-correct or initiate new models.

Turning now to FIG. 7, a technique 700 is shown that can be performed by a computing system to transform the material purchasing transactions and external index data for a PNO candidate into the input features for the machine learning model. According to particular implementations, A PNO candidate can be defined by its combination of material ID (also known as a stock keeping unit (SKU)) and unit of measure (UoM). The types of features that are extracted include trend and correlation estimates. For instance, in the depicted example, external index data (702) and purchasing transactions (704) are accessed. Then, the external index data can be filtered and cleansed (706) while the purchasing transactions can be filtered, aggregated, and cleansed (708). For instance, filtering and cleansing the external index data may involve extracting indices associated with a SKU, whereas filtering, aggregating and cleansing the purchasing transactions may involve aggregating to an index time interval. The data processed in steps 806 and 808 can then be combined (710), and that combine data can be used to extract one or more features (712). For instance, at step 712 trends, counts, and correlations can be extracted from the combined data.

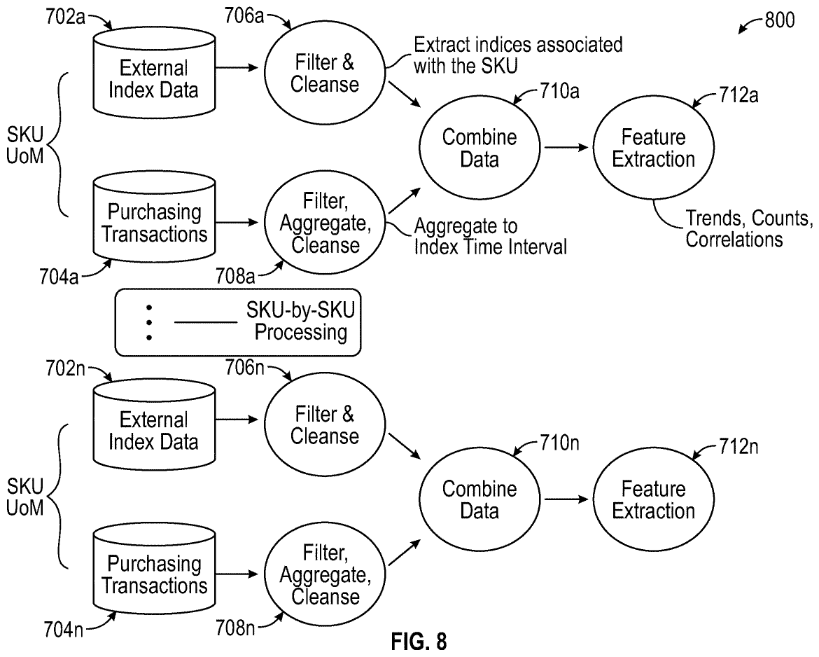

FIG. 8 illustrates multiple techniques 700 being performed. Specifically, systems can be configured to perform technique 800 across multiple SKUs and PNO candidates. As a result, the systems and techniques disclosed herein provide scalability and allow multiple techniques 700 to be performed at the same or substantially similar time.

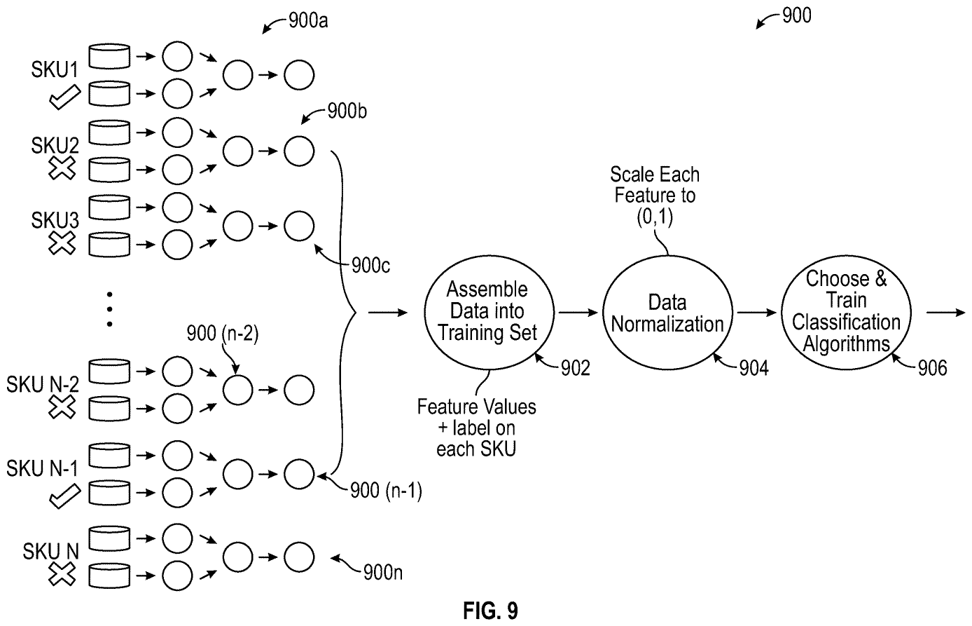

FIG. 9 illustrates a PNO machine learning pipeline 900 that takes advantage of the scalability illustrated in FIG. 8. For instance, in the depicted example, there are six techniques 900a-900n depicted (although many more can be processed at the same or substantially similar time). The results of any one of technique 700 can be labeled with positive or negative PNO label based on one or more of pre-defined rules, review by subject matter experts, or unsupervised machine learning detection. In the depicted example, techniques 900a and 900(n−1) are identified as having positive PNO labels while the results of techniques 900b, 900c, 900(n−2) and 900n are identified as having negative PNO labels.

As part of the pipeline 900, both the identified labels and the extracted features of respective techniques 900a-900n for each associated SKU are assembled into a training data set (902). Data normalization is then performed on training data set (904), resulting in the training data have ranges between 0 and 1. The normalized data is then provided to a ML model for training (906). For instance, the ML can process the data during training, and the trained ML generates predictions. The output is a ML model that predicts price negotiation opportunities based on PNO candidate features. According to particular implementations, the ML model is trained with supervised learning using the labeled training dataset.

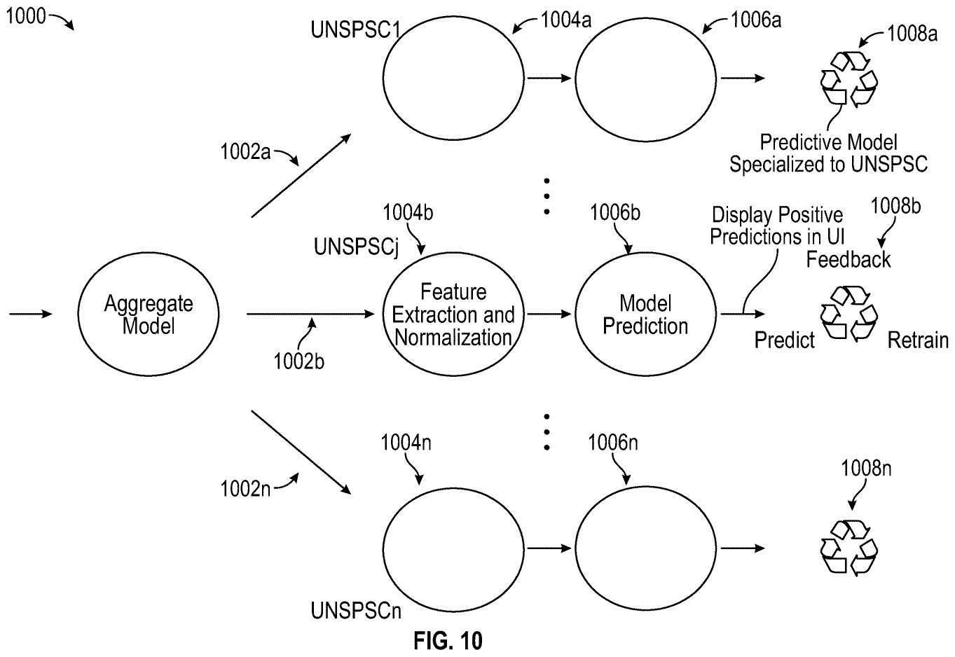

FIG. 10 depicts an example technique 1000 that can leverage trained ML models described above to further specialize the ML model for a particular type of data or portions of data. Within the ML framework there is the option to create models specialized to specified partitions of the data. The output of FIG. 9 is the aggregate model that is trained on the full training dataset and is the seed that is distributed to the targets of specialization. The diagram shows specialization to UNSPSC. That is, the ML model can be produced for a specified UNSPSC. For instance, the ML model can be tailored to one or more specific segments, families, classes, or commodities within the UNSPSC taxonomy. As depicted, the ML can be generated for any number of particular UNSPSC uses (1002a-1002n). Then, feature extraction and normalization can be performed for the specific specialization (1004a-1004n). The specialized ML models for the respective UNSPSC specializations can then be used to make predictions (1006a-1006n). Positive predictions can be presented in a user interface, any feedback pertaining to the positive predictions can be used to retrain or otherwise improve the ML model (1008a-1008n).

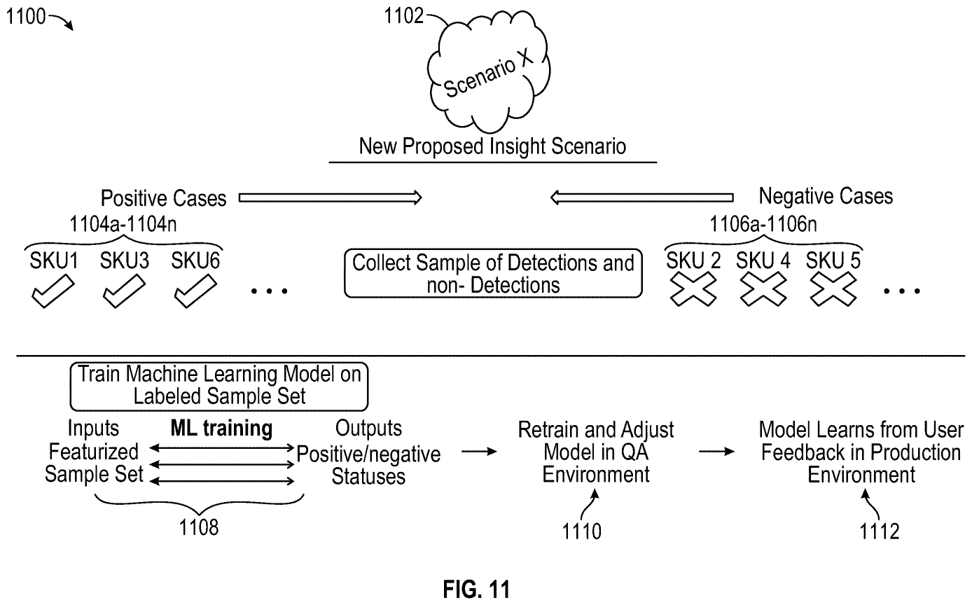

FIG. 11 depicts an example use case 1100 utilizing aspects of the present disclosure. In the example use case 1100 a new price negotiation opportunity scenario (e.g., scenario X 1102) is proposed by the organization, and it represents a new and distinctive data pattern. Utilizing the ML pipeline 900, both positive cases 1104a-1104n and negative cases 1106a-1106n can be identified. The labels of cases 1104a-1104n and 1106a-1106n are then combined with features calculated for each SKU, and a machine learning model is trained on that data (1108). Model predictions generated by the initially trained ML model are brought to the quality assurance (QA) environment for testing (1110). Depending on the results of the testing, the model can be retrained and adjusted, yielding an improved ML model. The predictions of the updated model are then deployed to the production environment, where the ML may continue to learn based on the user feedback loop(s) (1112), such as the feedback loops described elsewhere in this specification.

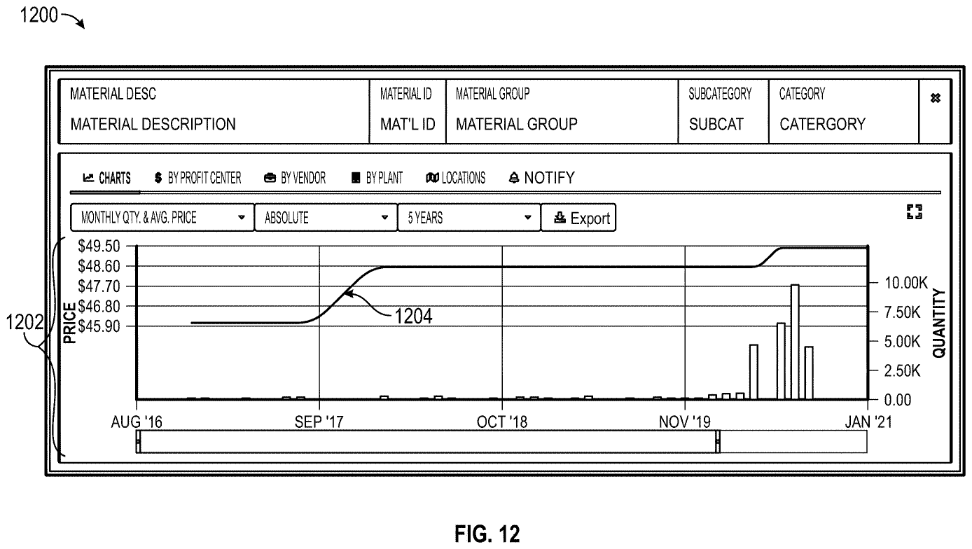

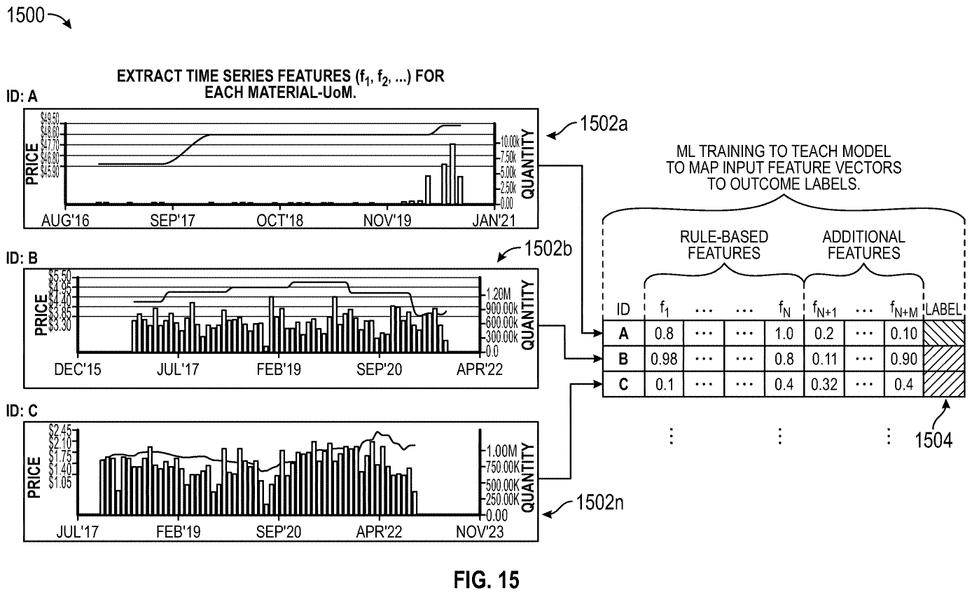

FIGS. 12-18 are generally directed to various techniques related to both rule-based and machine-learning based PNO determinations. To better appreciate the advantages of a ML approach, a rules-based approach is first discussed, and then specifics of an ML implementation are described. In particular FIGS. 12-14 demonstrate a rules-based approach, whereas FIGS. 15-18 describe various ML based approaches. As previously described, the price negotiation opportunity detection algorithm (PNO) uses rule-based pattern recognition to identify company-sourced materials for which the vendor pricing is (1) divergent to deflating market trends and/or (2) divergent to increasing quantity trends presenting opportunities for a company to negotiate price reductions for these materials. Detections are made at the level of Material ID and Unit of Measurement and are based on data features derived from multiple underlying data streams including: (a) material purchase price history, (b) material purchase quantity history, and (c) 3rd party indices that are associated with the material. In addition to other features, PNO computes time series linear trends within the time frame defined as the recent past and computes the correlation coefficients between price and each index within a time frame preceding the recent past. PNO also computes a weighted opportunity score based upon the feature values and applies thresholding logic to determine the classification of the material. Feature weights and thresholds are manually tuned to configure the algorithm to detect the distinctive data patterns corresponding to different insight scenarios.

As should be appreciated in light of the discussion here, the PNO algorithm can be tuned to identify different insight scenarios, and one such scenario is Price/Quantity PNO. Price/Quantity PNO occurs when the recent unit price trend is non-negative and the quantity trend is positive for a Material-UoM (e.g., Material ID+Unit of Measurement combination). Regarding units of measurement, a given material can be bought in a range of different units of measurement (packs, eaches, kilograms, pounds, etc.) with each unit corresponding to a different price scale. To control for this type of price variation, the PNO algorithm operates on data grouped by Material ID and Unit of Measurement to ensure that the underlying transactions have a common price scale.

FIG. 12 depicts an example user interface 1200 for illustrating a potential PNO. For instance, the user interface may present a graph 1202 or other visual representation that presents transaction-based data for a material purchased by the company. For instance, in the depicted example, the line 1204 of graph 1202 represents the average monthly unit price, and the bars are the total monthly purchased quantities for the material. This material was flagged by Price/Quantity PNO detection because the monthly quantity totals increased substantially relative to the historical level without a corresponding decrease in unit price presenting an opportunity for the company to negotiate a price reduction with the vendor.

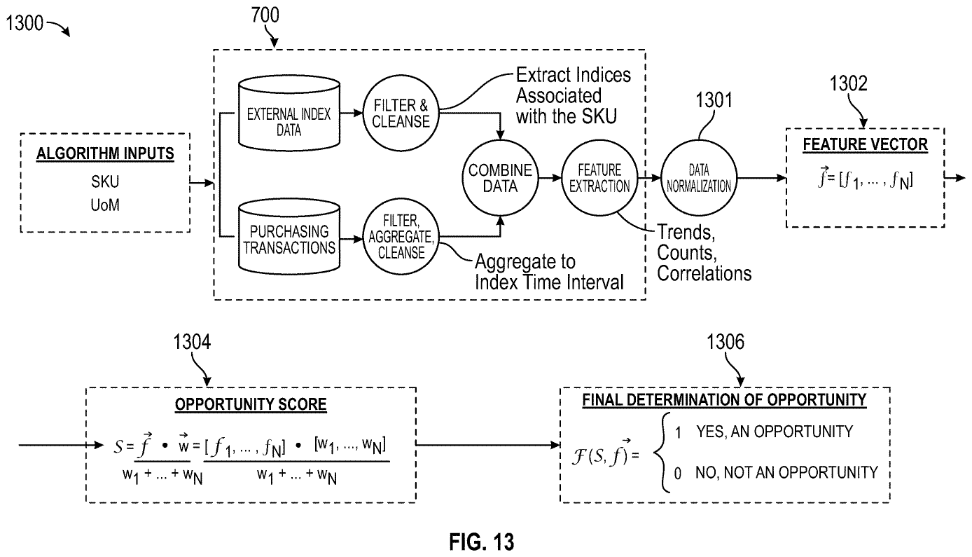

FIG. 13 illustrates depicts a technique 1300 that can be used to process external index data, which can be used for price/index based PNOs but is not necessarily required in other PNO implementations, such as price/quantity PNOs, which is described in more detail below. As shown, technique 1300 utilizes technique 700 and data normalization 1301 to generate one or more feature vectors 1302. According to particular implementations, the feature vector can be defined as \vec{f}=[f₁, . . . , f_{N}]. The feature vector 1302 can be used to determine a PNO opportunity score 1304. The opportunity score 1304 can be defined as

$$S = \frac{\vec{f} \cdot \vec{w}}{( {w}_{1} + {w}_{1} + … + {W}_{N} )} = \frac{[ {f}_{1} , … , {f}_{N} ] \cdot [ {w}_{1} , … , {w}_{N} ]}{( {w}_{1} + {w}_{1} + … + {w}_{N} )} .$$

In other words, the feature vector 1302 is weighted using a dot-product operation using one or more determined weights. In some implementations, these weights can be specified by a subject matter expert. In other implementations, the weights can be learned over time by a ML process. The weighted features can then be used to generate a final determination of a potential PNO 1306. According to particular implementations, the final determination can be expressed mathematically as

$$F ( S , \vec{f} ) = \{ \begin{matrix}1 \\ 0\end{matrix} ,$$

where a value of “1” represents the presence of a PNO opportunity, and a value of “0” represents the absence of a PNO opportunity.

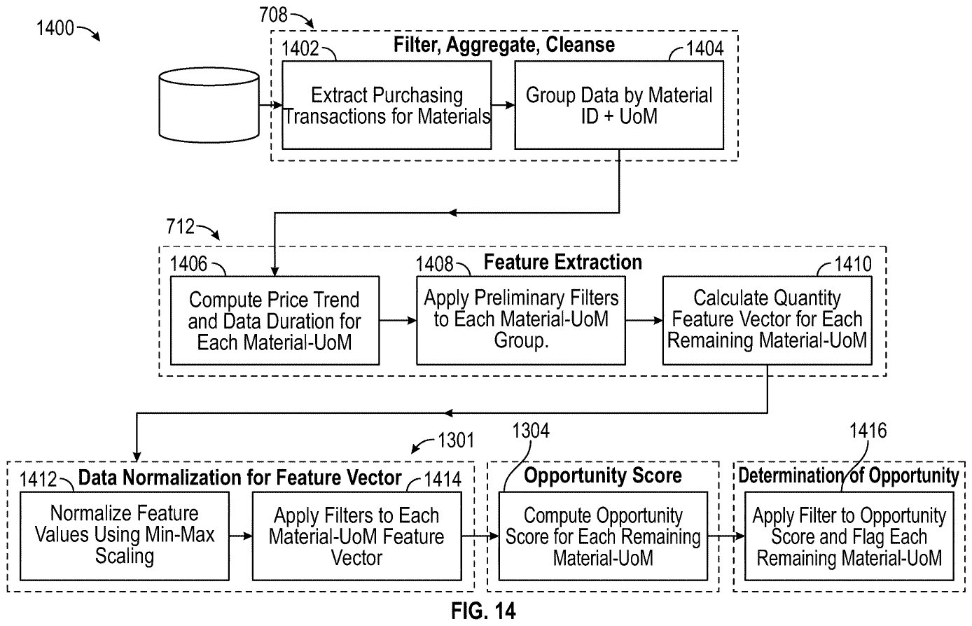

FIG. 14 shows a technique 1400 for a rules-based approach for price/quantity PNO. A system implementing technique 1400 leverages certain steps already described. For instance, extracting purchasing transaction for materials (1402) and grouping data by a Material ID and UoM (1404) are one example of filtering, aggregating, and cleansing (708), described above. Stated differently, purchasing transactions can be extracted from the database and grouped on Material ID and UoM. Each resulting group of transactions is then processed by rest of technique 1400.

Next, a system implementing technique 1400 can perform feature extraction (712) described above. For instance, a system implementing technique 1400 can compute price trend and data duration for each Material ID-UoM group (1406). Thereafter a system implementing technique 1400 can apply preliminary filters to each Material ID-UoM group (1408). In one implementation, step 1406 can include one or more of recording the date stamp of the oldest transaction for each Material-ID UoM group, calculate an average monthly unit price time series for each Material-ID UoM group, compute 18-month price trend for each Material-ID UoM group using linear regression. In one implementation step 1408 can include excluding one or more Material-ID UoM groups if there are fewer than three months of purchasing in said group during the previous 18 months, excluding one or more Material-ID UoM groups if the oldest transition is less than 18 months old, and excluding one or more Material-ID UoM groups if the trendline has a negative slope. Once the preliminary filters are applied, a system implementing technique 1400 can calculate quantity feature vectors for each Material ID-UoM group (1410).

According to one implementation, the last step of feature extraction (712) is to calculate a quality feature vector for each remaining Material-ID UoM group (1410). For instance, according to particular implementations, a feature vector-comprising measurable characteristics about the PNO pattern—is calculated for each remaining Material-UoM. An input to the feature vector calculation is the 6-month rolling average of the monthly quantity totals, which smooths the month-to-month quantity fluctuations and is used for calculating quantity trends. This can involve using one or more of the following characteristics: recency of the Material-ID UoM spend (Material-ID UoMs with current month data receive the max score and Material-ID UoMs with older data receive lower scores); percentage change of the linear 6-month quantity trend (trend calculated on the rolling 6-month quantity average); percentage change of the linear 18-month quantity trend (trend calculated on the rolling 6-month quantity average); percentage change of max rolling quantity in the previous 6 months to the max from the prior period; number of months with increasing rolling quantity in the previous 18 months; and year-over-year quantity.

A system implementing technique 1400 can perform data normalization for each feature vector (e.g., as describe above in connection with step 1301). For instance, according to particular implementations, at step 1412, each extracted feature vector can be normalized using Min-Max scaling. In one approach, a global minimum and maximum is determined for each feature vector component generated in step 1410 where global refers to the available materials in the dataset. Using the global minimum and maximum of each feature vector component, a min-max scalar formula, such as (V_{k,i}−V_{min,i})/(V_{max,i}−V_{min,i}), where V_{k,i} is the i^{th} component of the k^{th} vector and V_{max,i} and V_{min,i} are the global maximum and minimum values of the i^{th} component. Once computed, the feature vector can be normalized to the range of [0,1] using the min-max scalar. For instance, a feature vector component with value 50 where the component's global minimum and maximum are 0 and 100 would be normalized to a value of 0.5.

Filters can then be applied to each Material-UoM feature vector using various filter thresholds (1414). Material-UoMs that do not satisfy one or more of the filters are excluded as their measurable characteristics do not indicate price negotiation opportunities. The filters are chosen in a process that may involve subject-matter expert reviews of example data where the experts evaluate how algorithm outcomes change depending on different threshold values. Other implementations may use machine learning to define the threshold values. For instance, according to particular implementations, a filter value of T₁, where T₁ could be the filter for the first component of the feature vector such as the recency of the Material-UoM spend. Other filter values for components of the feature are also possible (e.g., T₂ through T_{N}), and may correspond to changes in trends over a 6- or 18-month period and a maximum change, to name a few examples. These threshold values may be used as part of determining an opportunity score in step 1304, described above.

According to particular implementations, computing an opportunity score for each remaining Material-UoM group can be done using pre-selected weights. For instance, the opportunity formula can be represented as follows S=(w₁f₁+w₂f₂+w₃f₃+w₄f₄+w₅f₅+w₆f₆)/(w₁+w₂+w₃+w₄+w₅+w₆), where

$$[ \begin{matrix}{w}_{1} \\ {w}_{2} \\ {w}_{3} \\ {w}_{4} \\ {w}_{5} \\ {w}_{6}\end{matrix} ] = [ \begin{matrix}\text{.1} \\ \text{.2} \\ \text{.02} \\ \text{.12} \\ \text{.38} \\ \text{.18}\end{matrix} ] .$$

As shown, the formula is a weighted sum of each feature vector's components where the values of the weights are listed in the example presented in the prior sentence. Using the opportunity score, a system implementing technique 1400 can identify and/or flag an opportunity with a score greater than a threshold value. For instance, according to one implementation, each Material-UoM group with an opportunity score over 0.6 can be flagged as a PNO opportunity (1416).

Turning now to FIGS. 15-18, ML approaches are described. In the above description of rule-based approaches, featuring weighting and thresholds are manually determined during algorithm development. The approach can be improved with machine learning in the following ways. For instance, model parameters, such as feature weights and thresholds, are “learned” (as described in more detail below) during model training, thus removing dependence on the SME for parameter tuning. However, the SME continues to play a role as their input is needed for outcome labeling (i.e., user/SME feedback) and in some instances for feature definitions. As another example, model accuracy can surpass rule-based accuracy as the model learns from SME feedback how to associate outcome labels with the input features. Relatedly, the model will react to a changing SME viewpoint on what constitutes a PNO by adjusting its parameters during training, whereas a rule-based algorithm is a static solution. As another example, the feature set can be larger and cover more characteristics about the data as the solution is no longer dependent on manual parameter tuning, which is time consuming and error prone. Instead, the model uses data to learn the input-to-output associations, which for certain problems would be difficult for a human to replicate. As yet another example, separate models can be trained to do PNO prediction for separate sets of Material-UoMs. The models can develop unique characteristics such as if the PNO signature varies between the Material-UoMs.

The training data for the model can be generated using the one or more techniques described in more detail below. The data is first extracted for materials with PNO classifications/labels and processed by the feature extraction pipeline to create the feature vectors. The training dataset is then created by matching these feature vectors to the corresponding PNO labels, and the data are then provided to a ML algorithm for model training—a process in which the model learns to associate feature values to the correct outcome label.

FIG. 15 shows an example workflow 1500 that creates the ML training data for price/quantity PNO detection. According to particular implementations, one or more feature vectors for one or more Material-UoM groups 1502a-1502n can be processed to extract time series features. Then, one or more features are provided to a machine learning approach to map input feature vectors to outcome labels (1504). In general, it is easier to use a large set of input features for a ML solution compared to a rule-based algorithm because the machine learning will determine the importance of each feature whereas with a rule-based algorithm the feature weights are manually determined.

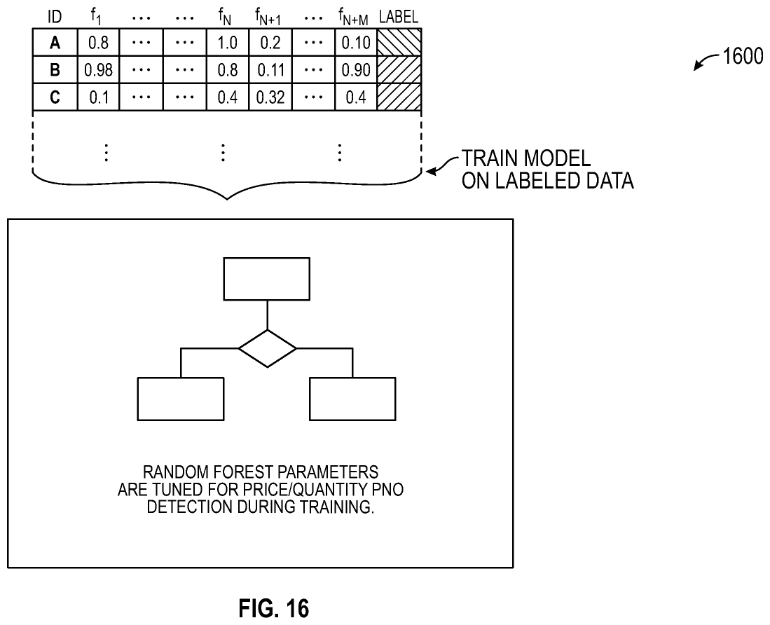

FIG. 16 depicts an example technique for ML training for price/quantity PNO detection. The training dataset created in FIG. 15 is used as an input to an ML algorithm (e.g., random forest as depicted in 1600) to train a machine learning model with parameter values estimated for price/quantity PNO detection. Once trained, these certain ML algorithms (e.g., random forest) can generate feature importance scores. These feature important scores measure how useful each feature is for model prediction.

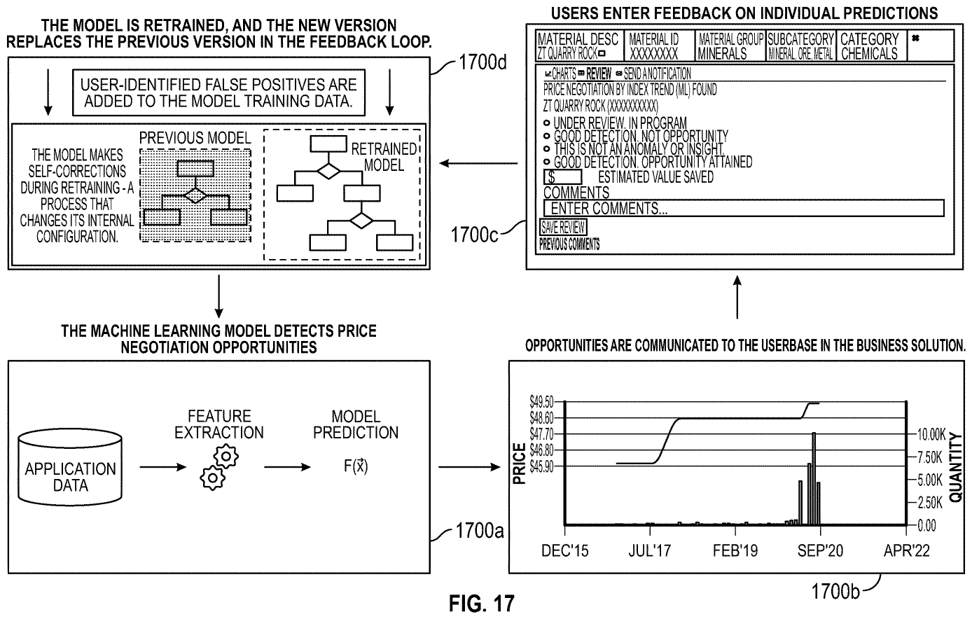

FIG. 17 depicts an example feedback loop 1700a-1700d that allows a user to provide feedback, which can be used to improve the underlying ML model. Box 1700a illustrates a process for generating ML predictions about the PNO-status of company-purchased materials. In box 1700b, materials that are predicted to have PNO are displayed in an application with charting and tabular data. Box 1700c shows how users can review individual predictions using a rendered user interface. Using the user interface, a user can identify one or more false detections. Data pertaining to the user-identified false detections are appended to the model's training dataset. In box 1700d, the model is then retrained on the updated training dataset to allow the model to make self-corrections and learn from the user feedback. The newly retrained model is then deployed to app and replaces the previous version. The feedback loop 1700a-1700d can then repeat with the next iteration of the use of the ML model.

Using one or more of the above approaches, the ML model can be used to identify PNO opportunities using a variety of metrics. In one implementation, spend recency can be used. According to particular implementations, spend recency is a metric that scores the age of the most recent spend for a material. Unit price history for a company-purchased material can be analyzed for each transaction for that material. The formula Max(I₁w₁,I₂w₂, I₃w₃, . . . , Iₙwₙ) where w₁<w₂<w₃< . . . <wₙ returns the maximum of the input list where each element has the form Iⱼwⱼ. Iⱼ represents the indicator function for timeframe j (where the timeframe can be a month) and equals 1 if transactions are present or equals 0 if no transactions are present in the subscripted timeframe. The weight wⱼ, for a timeframe j, increases in value from w₁ to wₙ. As such, the formula returns the maximum score if transactions are present in the current month, n, and lower scores whenever the latest transaction is from a previous month.

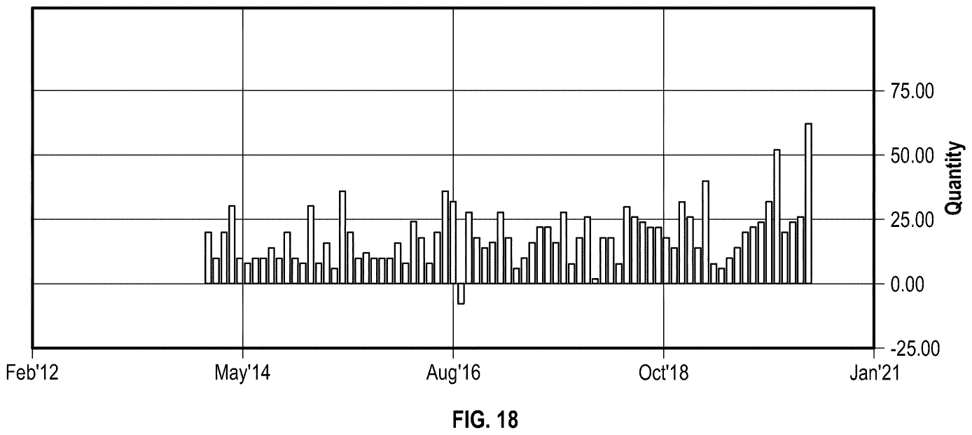

Another aspect of the present disclosure is that techniques disclosed herein is that the PNO algorithm may use linear regression to estimate trend on the 6-month moving average of the monthly quantity totals. FIG. 18 shows the monthly quantity totals for a material. The algorithm first transforms these bars into a 6-month moving average time series. The algorithm then fits two linear trendlines to the moving average time series—the first trend is fitted to the previous 6 months of the moving average, and the second is fitted to the previous 18 months of the moving average. The percentage changes across both trendlines are computed and saved as features, such as the percentage change of the linear 6-month quantity trend and the percentage change of the linear 18-month quantity trend. That said, it should be appreciated that systems and techniques disclosed herein may utilize different moving averages instead of the 6- and 18-month averages as described. By evaluating the ratio of the maximum of the quantity rolling average in the previous 6 months (or other designated period) to the maximum from the preceding months to assess the significance of the current quantity level relative to the historical levels that can be further used for PNO detection.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A method, comprising:
extracting, using one or more computer processors, a first set of procurement feature vectors from a first set of procurement transactions, each feature vector identifying one or more of the procurement transactions and including features associated with the one or more procurement transactions;
labeling, using the one or more computer processors, each feature vector with a label indicating if the feature vector is a procurement anomaly;
training, using the one or more computer processors, a machine learning model with the labeled feature vectors to identify procurement anomalies;
applying, using the one or more computer processors, a second set of procurement feature vectors to the machine learning model, the second set of procurement feature vectors extracted from a second set of procurement transactions, wherein applying includes identifying procurement anomalies in the second set of procurement transactions;
displaying, using the one or more computer processors and in a display device, the procurement anomalies to a user;
receiving, from the user and using the one or more computer processors, one or more indications of error in the identified procurement anomalies; and
modifying, using the one or more computer processors, the machine learning model based on the indications from the user.

2. The method of claim 1, wherein the feature vector labeler labels feature vectors based on pre-defined rules.

3. The method of claim 1, wherein the feature vector labeler labels feature vectors based on review by subject matter experts.

4. The method of claim 1, wherein the feature vector labeler labels feature vectors via unsupervised machine learning detection.

5. The method of claim 1, wherein the anomaly is a procurement opportunity.

6. The method of claim 1, wherein the procurement opportunity is a price divergence.

7. The method of claim 1, wherein the procurement opportunity is a price change.

8. The method of claim 1, wherein the machine learning model is trained to make predictions concerning a specific United Nations Standard Products and Services Code.

9. A method, comprising:
extracting a first set of procurement feature vectors from a first set of procurement indices, each feature vector identifying one of the procurement indices and including features associated with the one or more procurement indices;
labeling each feature vector with a label indicating if the feature vector is a procurement anomaly;
training a machine learning model with the labeled feature vectors to identify procurement anomalies;
extracting a second set of procurement feature vectors from a second set of procurement indices;
applying the second set of procurement feature vectors to the trained machine learning model;
identifying procurement anomalies in the second set of procurement indices;
displaying the procurement anomalies to a user;
receiving, from the user, one or more indications of error in the identified procurement anomalies; and
modifying the machine learning model based on the indications from the user.

10. The method of claim 9, wherein the feature vector labeler labels feature vectors based on pre-defined rules.

11. The method of claim 9, wherein the feature vector labeler labels feature vectors based on review by subject matter experts.

12. The method of claim 9, wherein the feature vector labeler labels feature vectors via unsupervised machine learning detection.

13. The method of claim 9, wherein the anomaly is a procurement opportunity.

14. The method of claim 9, wherein the procurement opportunity is a price divergence.

15. The method of claim 9, wherein the procurement opportunity is a price change.

16. The method of claim 9, wherein the machine learning model is trained to make predictions concerning a specific United Nations Standard Products and Services Code.

17. A procurement management system, comprising:
a memory, wherein the memory includes a first set of data, the data associated with procurements;
a feature extraction module connected to the memory, wherein the feature extraction module extracts a first set of procurement feature vectors from the first set of procurement data, each feature vector identifying one of the procurements and including features associated with the procurement;
a feature vector labeler connected to the memory, the feature vector labeler associating a label with each feature vector in the first set of feature vectors, the labels identifying procurement opportunities in the first set of feature vectors;
a machine learning modeler connected to the feature extraction module and to the feature vector labeler, the modeler including a model trained with the first set of feature vectors;
a display connected to the machine learning modeler, the display capable of displaying, to a user, procurement opportunities identified in feature vectors by the model and of receiving, from the user, indications when a feature vector is miscategorized,
wherein the machine learning modeler forms a retraining set of feature vectors based on the first set of feature vectors and the mischaracterized feature vectors and retrains the model.

18. The system of claim 17, wherein the procurement data is transaction data.

19. The system of claim 17, wherein the procurement data is based on an index of items.

20. The system of claim 17, wherein the feature vector labeler labels feature vectors based on pre-defined rules.

21-30. (canceled)
